(19) United States
(12) Patent Application Publication
(10) Pub. No.: US 2009/0174128 A1
(43) Pub. Date: Jul. 9, 2009

(54) DEVICE FOR REGULATING THE ELASTIC FORCE EXERTED BY A PLURALITY OF SPRINGS

(75) Inventor: Armando Donati, Rodengo Saiano (IT)

Correspondence Address: LUCAS & MERCANTI, LLP, 475 PARK AVENUE SOUTH, 15TH FLOOR, NEW YORK, NY, 10016, US

(73) Assignee: DONATI S.P.A., Rodengo Saiano (IT)

(21) Appl. No.: 12/297,846

(22) PCT Filed: Apr. 18, 2007
(86) PCT No.: PCT/IB07/01008

§ 371 Date: Oct. 20, 2008

(30) Foreign Application Priority Data
Apr. 21, 2006 (IT) MI2006A000808

(51) Int. Cl. F16F 3/00

(52) U.S. Cl. 267/151; 267/170; 267/172

(57) ABSTRACT

A device for adjusting the elastic force exerted by a plurality of springs, wherein there are provided main springs and auxiliary springs connected to two mutually movable structures. There are provided means for operatively coupling or uncoupling the connection of the free end of one or more of the auxiliary springs with respect to at least one of the structures.

### TECHNICAL FIELD OF THE INVENTION

The present invention relates to a device for adjusting the elastic force exerted by a plurality of springs.

### BACKGROUND OF THE INVENTION

Devices of this type are applied, for example, in tilting or synchronized chairs and armchairs, which are provided with the possibility of varying the tilt of a movable frame, either of the seat or of the backrest, with respect to a structure integral with the pedestal of the chair.

In these types of chairs, there is provided an assembly to elastically return the movable frame of the backrest or of the seat to a pre-established position when it is not subjected to stress by a user. Elastic return assemblies of known type are generally adjustable and include, for example, one or two springs which can both be compressed (or extended) to vary the elastic reaction thereof.

Although this solution may be considered acceptable from a functional viewpoint, adjustment can require considerable effort and can be difficult for the user, as preloaded springs are operated.

### SUMMARY OF THE INVENTION

This being stated, an object of the present invention is to propose a device that allows easier adjustment of the elastic force exerted by a plurality of springs.

Another object of the present invention is to propose a device of the aforesaid type which allows more gradual variation of the elastic force exerted by a plurality of springs.

These objects are attained by the present invention, which relates to a device to adjust the elastic force exerted by a plurality of springs as claimed in claim 1. Further characteristics and advantages are set forth in the dependent claims.

A device according to the present invention includes at least one main spring connected at the ends thereof to a steady structure and to a movable structure respectively, and is characterized by including one or more auxiliary springs having one end thereof fixedly connected to at least one of the structures and means for operatively coupling or uncoupling the free end of one or more of the auxiliary springs to the other of the structures.

This solution allows gradual adjustment to be performed by enabling or excluding the connection of one or more of the auxiliary springs.

The means for operatively coupling or uncoupling the free end of one or more of the auxiliary springs may include pins movable between an engaged position and a disengaged position with holes provided in coupling elements fixed to the free ends of the auxiliary springs, or directly with hooks or eyelets which form the free ends of the auxiliary springs. In this case, said means for coupling or uncoupling the free end of one or more of the auxiliary springs act as means suitable for enabling or disabling the connection of the free ends of the auxiliary springs to the relative structure.

In particular, said means for enabling or disabling the connection of the free end of one or more of the auxiliary springs may include pins movable between an engaged position and a disengaged position.

According to a peculiar embodiment of the present invention, the pins are engaged slidingly in guide holes produced in a block integral with the steady structure and elastic means are provided, which act on the pins to return them towards the disengaged position.

According to a preferred embodiment of the present invention, the means for operatively coupling or uncoupling the free end of one or more of the auxiliary springs include at least one cam member to which the free ends of the auxiliary springs engage. Said cam member is arranged to selectively move the free ends of the auxiliary springs from an engaged position of one or more auxiliary springs with both said structures to a disengaged position of one or more auxiliary springs with one or the other of said structures, or vice-versa.

In particular, the cam member may be rotatable with respect to the free ends of the auxiliary springs and it may comprise at least one portion in which one or more springs of said auxiliary springs are loaded and at least one portion in which one or more springs of said auxiliary springs are unloaded.

In this way, when one or more auxiliary springs are loaded they are operatively engaged with the relative structure, thus applying their resilient force to both the structures of the chair, while of course when they are unloaded they don't apply any resilient (i.e. elastic) force to said structures of the chair.

Moreover, since the cam member may be shaped to selectively engage at the same time one or more free ends of the auxiliary springs, the resilient force applied by the auxiliary springs can be finely adjusted.

The solution proposed with the present invention also offers the particular advantage of allowing selection of the coupling/uncoupling of each auxiliary spring only in the position in which all the springs of the device, or at least the auxiliary springs, are in an inactive condition, i.e. in the condition in which they do not exert any elastic reaction force.

### BRIEF DESCRIPTION OF THE DRAWINGS

Further characteristics and advantages of the present invention will be more apparent from the description below with reference to the attached schematic drawings, wherein:

FIG. 1 is a top perspective view of a possible embodiment of the present invention;

FIG. 2 is a cross section view of some elements of the device in FIG. 1;

FIG. 3 is a longitudinal section view of the device in FIG. 1;

FIG. 4 is a bottom perspective view of some elements of the device in FIG. 1;

FIG. 5 is a top perspective view of another embodiment of the present invention;

FIG. 6 is a bottom perspective view of a detail of the device in FIG. 5;

FIG. 7 is a top perspective view of another embodiment of the device according to a preferred aspect of the present invention; and

FIGS. 8 and 9 are lateral—section, schematic, views of part of the device of FIG. 7, taken when the movable structure of the device is in two different angular position with respect to the relative steady structure.

### MODES FOR CARRYING OUT THE INVENTION

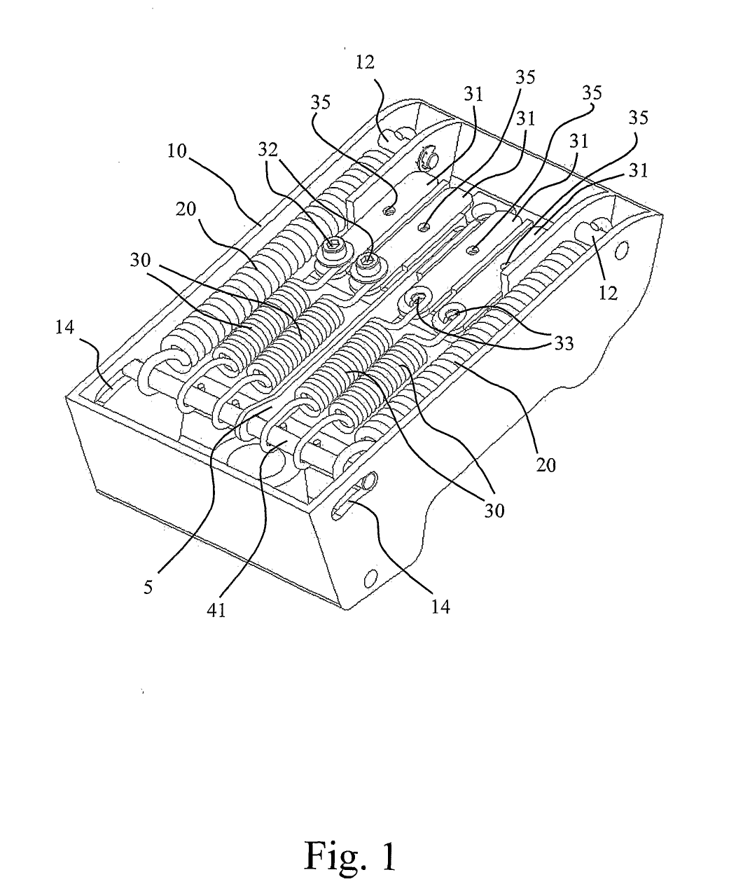

In the embodiment represented in FIG. 1, the device to adjust the elastic force exerted by a plurality of springs includes a steady structure which includes a casing 10 in which two main springs 20 and four auxiliary springs 30 are housed.

The main springs are connected with one end thereof to the steady structure or casing 10 by means of bars 12 integral with said casing, while the other end of the main springs 20 is connected to a bar 41 which forms part of a structure movable with respect to the steady structure. The bar 41 slides in slots 14 produced in the casing 10 of the steady structure.

The auxiliary springs 30 are connected with one end thereof to the bar 41 of the movable structure while the other end thereof is fixed to coupling elements 31 between the auxiliary springs 30 and the means to enable or disable the connection of the free end of said auxiliary springs 30 to the steady structure 10. The coupling elements 31 are produced in the form of plates fixed to the respective ends of the auxiliary springs 30 by means of screws 32 engaged in corresponding threaded holes 33.

FIG. 1 also shows a rod 5 of a mechanism used to block relative movement between the steady structure 10 and the movable structure 41.

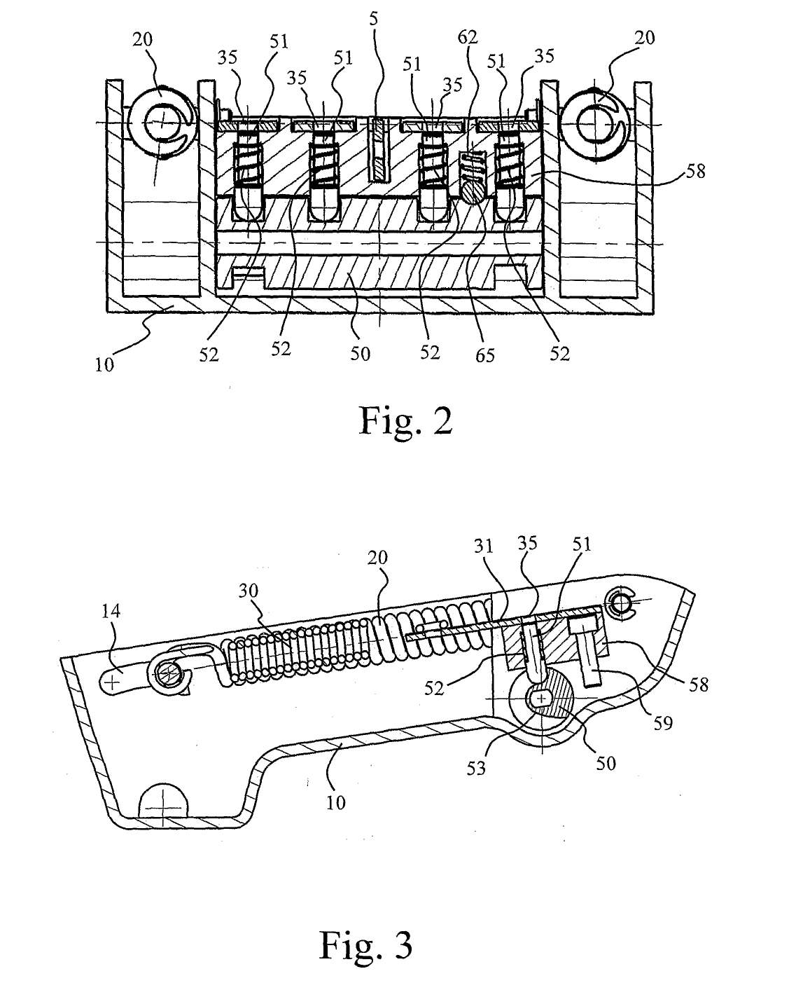

FIGS. 2, 3 and 4 describe in greater detail the means to enable or disable the connection of the auxiliary springs 30 to the steady structure 10.

The plates 31 are provided with smooth through holes 35 in which there can be engaged movable pins 51, which can be moved between a position engaging the holes 35 and a disengaged position therefrom.

The pins 51 are slidingly engaged in guide holes produced in a block 58 made integral with the steady structure 10, e.g. by means of a screw 59 (FIG. 3). Guide races for the plates 31 are also produced on the block 58.

There are associated with the pins 51 elastic means, such as springs 52, acting on the pins to return them towards the position disengaged from the holes 35 of the plates 31.

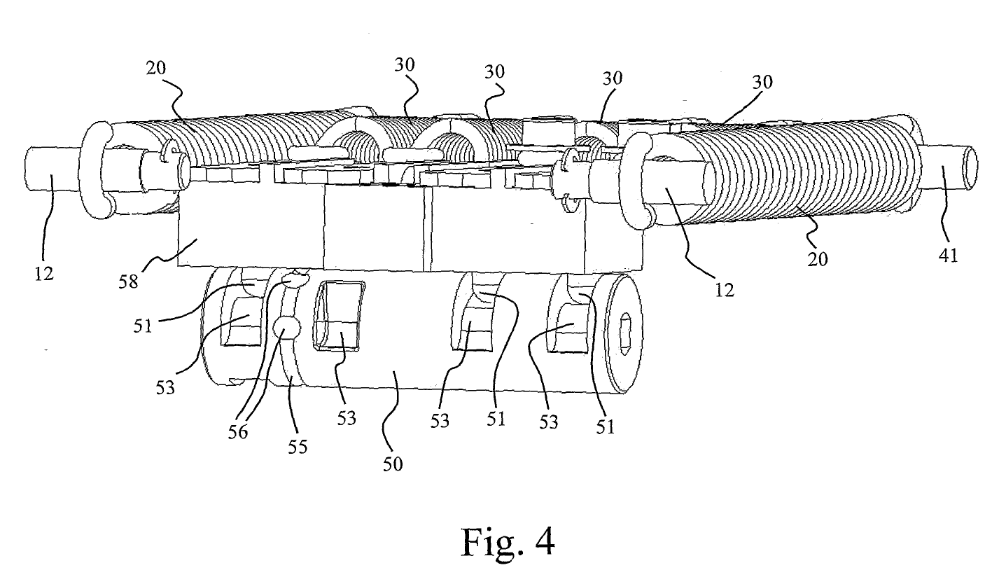

Movement of the pins 51 is performed by means of a selection member 50 having cam surfaces 53 (FIGS. 3 and 4) with shaped profiles so as to determine a desired engaged/disengaged sequence between the pins 51 and the holes 35.

The selection member 50 is connected to the steady structure or casing 10 and is rotatable with respect thereto, so that rotation of the selection member 50 can move each pin 51 in succession between the engaged/disengaged positions.

In the embodiment represented here, there are also provided means to detect the angle of rotation of the selection member 50 to indicate the correct engaged/disengaged positions of each of said pins 51. In particular, with reference to FIGS. 2 and 4, in the block 58 there is housed a ball 65 thrust by a spring 62 against the surface of the rotating selection member 50. The latter is provided with a surface guide groove 55 (FIG. 4), along which seats 56 are positioned at pre-established intervals for partial abutment of the ball 65.

Operation of the device according to the present invention is therefore easy to understand. When all the main springs 20 and the auxiliary springs 30 are in the released condition, i.e. in the position illustrated in FIG. 1, the holes 35 in the plates 31 are axially aligned with the pins 51.

The selection member 50 can therefore be rotated until detecting the first click of the ball 65 which abuts in the first seat 56. During this rotation, one of the cam surfaces 53 thrusts the respective pin 51 towards the position of engagement with the respective hole 35, until the ball 65 reaches the seat 56, thereby indicating that a first pin 51 has completely reached the engaged position thereof in the corresponding hole 35.

If at this point rotation of the selection member 50 is interrupted, the elastic force will be exerted by the main springs 20, always in active condition, and by only one of the auxiliary springs 30. If instead rotation of the selection member 50 continues, detecting the positions in which the ball 65 is subsequently thrust into the consecutive seats 56, other pins 51 gradually engage with other holes 35, thus determining the number of auxiliary springs 30 that add their elastic return force to the force exerted by the main springs 20.

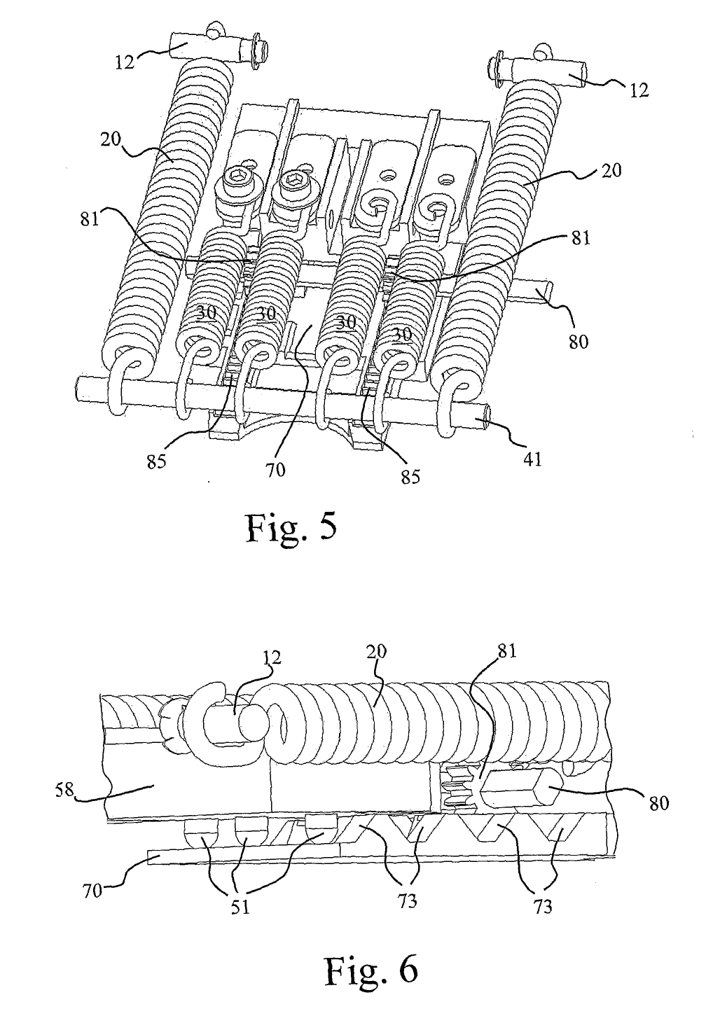

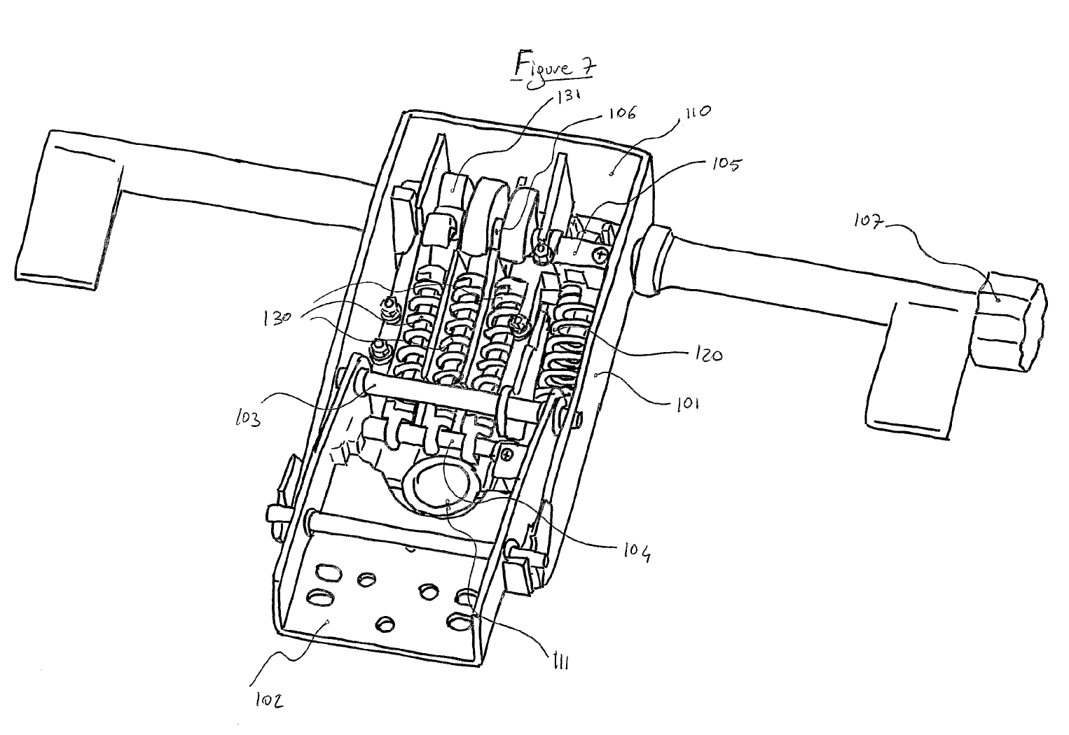

FIGS. 5 and 6 illustrate another embodiment of the present invention. Parts in common with the previously described embodiment are indicated by the same reference numerals.

In this embodiment, the means to enable or disable the connection of the free end of the auxiliary springs 30 include a selection member composed of a slide 70 movable in translation and provided with sloping surfaces 73 to move the pins 51 between the respective engaged and disengaged positions.

The movable slide 70 is mounted integral inside the structure and is movable in translation with respect thereto by means of a rack mechanism. In fact, a control rod 80 allows rotation of a pair of pinions 81 engaged on respective racks 85 which move the slide 70 in translation, thereby varying the position of the various sloping surfaces 73 with respect to the pins 51 determining movement thereof between the two aforesaid positions.

Although not represented, means to detect the position of the plates 70 in translation can also be provided in this embodiment, to indicate the correct engaged/disengaged positions of the pins 51. For example, in a similar way to the previous embodiment, these means can include a ball engaged in a rectilinear groove produced in the slide 70, parallel to the series of sloping surfaces 73 acting on the pins 51, in which seats are provided for abutment of the ball in pre-established positions.

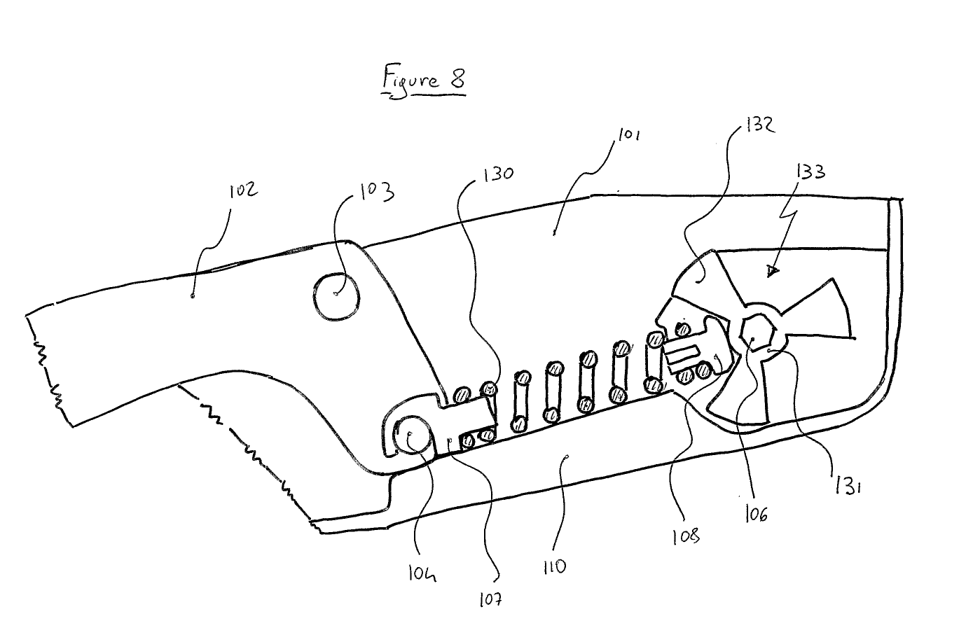

With reference now to the preferred embodiment of the device shown in FIGS. 7-9, said device for adjusting the elastic force exerted by a plurality of springs comprises a steady structure 101 and a movable structure 102 linked by means of a pivot 103 to the steady structure 101, one main spring 120 fixed between a bar 104, hinged to the movable structure 102, and a stop 105 integral to the casing 110 of the steady structure 101. The device also includes three auxiliary springs 130 which are linked, at one end, to the bar 104, while at the other end they can be operatively coupled to a cam member 131, which is rotatably linked to the casing 10 of the steady structure 101.

As usual in the art, the steady structure 101 is fixed to the vertical post (pedestal) 111 of the chair and it bears the seat of the chair, while the movable structure 102 bears the backrest of the same chair.

The main spring 120, as in the embodiments described above with reference to the FIG. 1-5, cannot be uncoupled to the steady and movable structures 101, 102 of the device, thus providing a minor resilient (elastic) force opposing to the movement of the movable structure 102 with respect to the steady structure 101.

On the other hand, the auxiliary springs 130 are fixedly linked, via the bar 104, to the movable structure 102, but they can be selectively coupled or uncoupled to the steady structure 101, by means of said cam member 131, that constitutes the aforesaid means for operatively coupling or uncoupling each one of the free ends of the auxiliary springs 130 to said steady structure 101.

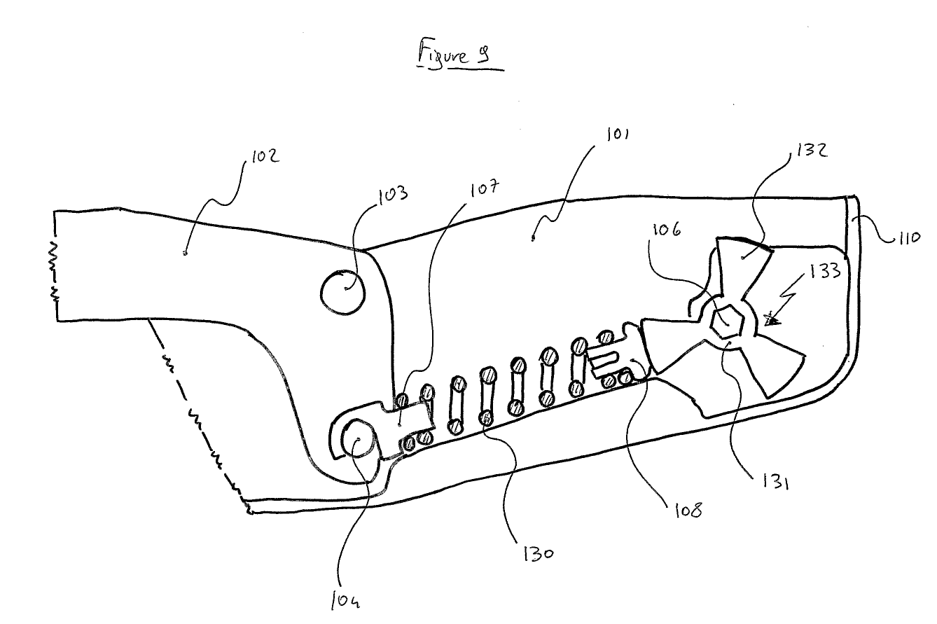

More particularly, as shown in FIGS. 8 and 9, each auxiliary spring 130 includes at one end a hooked cap 107 that is linked to the bar 104 and at the other free end a cap 108 which abuts onto the external surface of the cam member 131. Moreover, the cam member 131 is fixed to a rotating shaft 106 pivoted to the casing 110 of the steady structure 101. Shaft 106 can be rotatably actuated by the user by means of a handgrip 107.

As can be best seen in FIG. 7, the cam member 131 comprises—in the preferred embodiment herein described—three multi-lobed cam wheels, integral one to the other, each one of said cam wheels being arranged in correspondence to the abutting cap 108 of each auxiliary spring 130.

The external surface of each wheel of the cam member 131 includes protruding portions 132 and hollow portions 133 to which, as a function of the angular position reached by said cam wheel, selectively abuts the related cap 108 (or—in an alternative embodiment not shown herein—the free end of the proper auxiliary spring 130).

The angular size of the hollow portions 133 and of the protruding portions 132 varies as a function of the auxiliary spring 130 engaged with the relative cam wheel, in such a way that the three springs 130 can be selectively engaged, via their cap 108, with the correspondent protruding portions 132 of the proper cam wheel, as a function of the rotation angle of the shaft 106.

More in detail, auxiliary springs 130 and the multi-lobed wheels of the cam member 131 are shaped and arranged such a way that when the cap 108, or in general one end (not shown), of a spring 130 abuts against one protruding portion 132 of the cam member 131, the relative spring 130 takes a loaded configuration, in such a way that said spring 130 can apply its resilient force against the movement of the structure 102, in addition to the main spring 120, thus increasing the overall elastic force contrasting the movement of the movable structure 102. On the contrary, when the cap 108, or one end (not shown), of a spring 130 lies within one hollow portion 133 of the cam member 131, the spring 130 takes a unloaded configuration, such as it doesn't apply any resilient reaction force to the system. Thus, FIG. 8 shows an unloaded auxiliary spring 130, i.e. an auxiliary spring 130 that doesn't apply any resilient reaction force to the structures 101, 102, while FIG. 9 shows the same auxiliary spring 130 in a loaded configuration, applying a resilient reaction force between said structures 101, 102.

According to a preferred aspect of the present invention, as already cited, the hollow portions 133 and the protruding portions 132, as well, are so sized that engaging of the free end—or of the cap 108—of each auxiliary spring 130 is gradual—i.e. in progression—as a function of the rotation angle of the cam member 131.

This means that, for instance, a protruding portion 132 of a first cam wheel overlaps and extends over the corresponding protruding portion of the adjacent (second) cam wheel and this protruding portion of the second cam wheel, in turn, overlaps and extends over the corresponding protruding portion both of the first and the third adjacent cam wheels. In this way when the protruding portion of the third cam wheel engages the free end of the respective auxiliary spring, the free ends of the other auxiliary springs may lie in the hollow portions of their respective cam wheel. A slight rotation of the cam member 131, may also put the free end of the central auxiliary spring in engagement with the protruding portion of the respective cam wheel, still maintaining the free end of the first auxiliary spring in the hollow portion of its cam wheel. A further rotation of the cam member 131 may finally put all the free ends of the three auxiliary springs 130 in engagement with the protruding portion of their relative cam wheel.

Of course, angular positions of the cam member 131 are provided where the free ends of all the three auxiliary springs 130 lie unloaded in a hollow portion 133 of their respective cam wheel of the cam member 131.

Various modifications can be made to the embodiments represented here without departing from the scope of the present invention. For example, for the sake of clarity, reference has been made to a structure which is movable with respect to a structure defined as rigid, but it is apparent that the references to these structures could also be inverted, just as the structure defined as rigid could in turn also be movable with respect to any other structure not represented.

For example, by suitably modifying the ends of the auxiliary springs 30 and providing suitable guides therefor, the pins 51 can also be engageable with the holes provided in hooks or eyelets that form the free ends of said auxiliary springs, therefore without using the coupling elements 31. In the same way, the number of springs 20 or 30 can differ from the number represented and the springs 20 and/or 30 can also be, entirely or in part, of the type stressed in compression rather than in traction.

Finally, the form, arrangement and number of cam surfaces 53 provided on the rotating selection member 50, as well as of the cam member 131 provided on the shaft 106, can also differ from the number represented, to adapt to different needs and/or different configurations and arrangements of the auxiliary springs 30, 130.

1. A device to adjust the elastic force exerted by a plurality of springs, including at least one main spring connected at the ends thereof to a steady structure and to a movable structure respectively, characterized by including one or more auxiliary springs having one end thereof fixedly connected to at least one of said structures and means for operatively coupling or uncoupling the free end of one or more of said auxiliary springs to the other of said structures.

2. The device as claimed in claim 1, wherein said means for operatively coupling or uncoupling the free end of one or more of said auxiliary springs include pins movable between an engaged position and a disengaged position with hooks or eyelets which form the free ends of said auxiliary springs.

3. The device as claimed in claim 1, wherein said means for operatively coupling or uncoupling the free end of one or more of said auxiliary springs include pins movable between an engaged position and a disengaged position with holes provided in coupling elements fixed to the free ends of said auxiliary springs.

4. The device as claimed in claim 2, wherein said pins are slidingly engaged in guide holes produced in a block integral with said steady structure.

5. The device as claimed in claim 4, wherein there are provided elastic means acting on said pins to return them towards said disengaged position.

6. The device as claimed in claim 2, wherein said means for operatively coupling or uncoupling the free end of one or more of said auxiliary springs include at least one selection member having cam surfaces to move said pins between said engaged position and said disengaged position.

7. The device as claimed in claim 6, wherein said selection member is integral with said steady structure and rotatable with respect thereto.

8. The device as claimed in claim 6, wherein there are provided means to detect the angle of rotation of said selection member to indicate the correct engaged/disengaged positions of each of said pins.

9. The device as claimed in claim 2, wherein said means for operatively coupling or uncoupling the free end of one or more of said auxiliary springs include at least one selection member composed of a slide movable in translation and provided with sloping surfaces to move said pins between said engaged position and said disengaged position.

10. The device as claimed in claim 9, wherein said selection member is integral with said steady structure and movable in translation with respect thereto by means of at least one rack coupled with at least one rotating pinion.

11. The device as claimed in claim 9, wherein there are provided means to detect the position in translation of said selection member to indicate the correct engaged/disengaged positions of each of said pins.

12. The device as claimed in claim 1, wherein said means for operatively coupling or uncoupling the free end of one or more of said auxiliary springs include at least one cam member to which the free end of one or more of said auxiliary springs engages, said at least one cam member being arranged to move said free end of one or more of said auxiliary springs from an engaged position of one or more of said auxiliary springs with both said structures to a disengaged position of one or more of said auxiliary springs with one or the other of said structures, or vice-versa.

13. The device as claimed in claim 12, wherein said at least one cam member comprises at least one portion in which one or more springs of said auxiliary springs are loaded and at least one portion in which one or more springs of said auxiliary springs are unloaded.

14. The device as claimed in claim 12, wherein said at least one cam member is rotatable with respect to the free end of one or more of said auxiliary springs.

15. The device as claimed in claim 12, wherein said at least one cam member includes a multi-lobed wheel.

16. The device as claimed in claim 12, wherein said at least one cam member is shaped to selectively engage at the same time one or more free ends of said one or more auxiliary springs.

17. The device as claimed in claim 1, wherein said steady structure has a casing which houses said principal and auxiliary springs, as well as said means for operatively coupling or uncoupling the connection of the free end of one or more of said auxiliary springs to said movable structure.

18. The device as claimed in claim 1, wherein said movable structure includes at least one bar slidable in slots produced in the casing of said steady structure.

19. The device as claimed in claim 1, further including means to block the relative movement between said structures connected by said springs.
